(19) United States
(12) Patent Application Publication
(10) Pub. No.: US 2025/0192939 A1
(43) Pub. Date: Jun. 12, 2025

(54) FRONTHAUL BANDWIDTH REDUCTION IN RADIO ACCESS NETWORK

(71) Applicant: CommScope Technologies LLC, Claremont, NC (US)

(72) Inventors: Irfaan Ahamed Salahuddeen, Acton, MA (US); Stuart D. Sandberg, Acton, MA (US); Christopher Goodman Ranson, Concord, VA (US); Boaz Pianka, Lexington, MA (US); Calogero Armao, Saronno (IT); Sunit Kumar Sharma, Groton, MA (US)

(73) Assignee: CommScope Technologies LLC, Claremont, NC (US)

(21) Appl. No.: 18/840,821

(22) PCT Filed: Feb. 22, 2023
(86) PCT No.: PCT/US2023/063026

§ 371 Date: Aug. 22, 2024

(30) Foreign Application Priority Data
Feb. 22, 2022 (IT) 102022000003305
Jul. 19, 2022 (IT) 102022000015177

(51) Int. Cl. H04L 5/00; H04W 74/0833

(52) U.S. Cl. CPC H04L 5/0048; H04W 74/0833

(57) ABSTRACT

Various techniques for reducing fronthaul bandwidth usage or contention in radio access networks are described. A base station is configured so that each of RUs is configured to: receive, at that RU, an SRS transmission from a UE; perform, by the RU, at least some of a high physical layer (PHY) baseband processing for the received SRS transmission; and transmit fronthaul data for the received SRS transmission to the distributed unit over the fronthaul network, wherein the fronthaul data comprises a payload including data generated in connection with performing at least some of the high PHY based processing for the received SRS transmission.

### CROSS-REFERENCE TO RELATED APPLICATIONS

This application claims the benefit of Italian Patent Application No. 102022000003305, filed on Feb. 22, 2022, and Italian Patent Application No. 102022000015177, filed on Jul. 19, 2022, both of which are hereby incorporated herein by reference in therein entirety.

### BACKGROUND

A Fifth Generation (5G) New Radio (NR) base station (also referred to as a “gNodeB” or “gNB”) is typically partitioned into one or more central unit entities (CUs), one or more distributed unit entities (DUs), and one or more radio units (RUs). In such a configuration, each CU implements Layer 3 and non-time critical Layer 2 functions for the gNB. Each CU is typically further partitioned into one or more control-plane entities and one or more user-plane entities that handle the control-plane and user-plane processing of the CU, respectively. Each such control-plane CU entity is also referred to as a “CU-CP,” and each such user-plane CU entity is also referred to as a “CU-UP.” Also, in such a configuration, each DU is typically configured to implement the time critical Layer 2 functions and at least some of the Layer 1 (also referred to as the “physical layer” or “PHY”) functions for the gNB. In this example, each RU is configured to implement the radio frequency (RF) interface and the physical layer functions for the gNB that are not implemented in the DU. The physical layer functions implemented in the DU are also referred to as the “upper” or “high” physical layer functions, and the physical layer functions implemented in the RU are also referred to as the “lower” or “low” physical layer functions.

Each RU is communicatively coupled to the DU serving it via a fronthaul network. The fronthaul network can be implemented using a switched Ethernet network, in which case each RU and each physical node on which each DU is implemented includes one or more Ethernet network interfaces to couple each RU and each physical node to the fronthaul network in order to facilitate communications between the DU and the RUs. The O-RAN Alliance has published a set of specifications for implementing various aspects of radio access networks. (The acronym “O-RAN” stands for “Open RAN,” where the acronym “RAN” stands for “radio access network.”) In particular, Working Group Four (WG-4) of the O-RAN Alliance is responsible for defining an open interface for DUs and RUs to communicate with each over a fronthaul network.

Where multiple RUs are used to implement a single gNB, multiple RUs can be used by the gNB to wirelessly transmit downlink data to a UE. The group of multiple RUs used by the gNB to wirelessly transmit to a UE is also referred to here as the “simulcast zone” for the UE. Also, multiple RUs can be used by the gNB to receive data wirelessly transmitted by a UE. The group of multiple RUs used by the gNB to receive data wirelessly transmitted by a UE is also referred to here as the “combining zone” for the UE.

In configurations where multiple RUs are used to implement a single gNB, fronthaul bandwidth usage increases if downlink data is wirelessly transmitted by the gNB to UEs using multiple RUs and if uplink data wirelessly transmitted from UEs is received by the gNB using multiple RUs. This is especially the case if the multi-RU gNB is configured to use “frequency reuse.” In this context, “downlink frequency reuse” refers to situations where separate downlink user data intended for different UEs is simultaneously wirelessly transmitted to the UEs using the same physical resource blocks (PRBs) for the same cell. Likewise, “uplink frequency reuse” refers to situations where separate uplink user data is simultaneously wirelessly transmitted from different UEs using the same PRBs for the same cell. Generally, for those PRBs where downlink or uplink frequency reuse is used, the respective simulcast zone or combining zones for the multiple UEs that are “in reuse together” have no RUs in common. Typically, frequency reuse can be used when the UEs in reuse together are sufficiently physically separated from each other so that the co-channel interference resulting from the different simultaneous wireless transmissions is sufficiently low (that is, where there is sufficient RF isolation).

Various techniques have been developed for reducing fronthaul bandwidth usage for downlink fronthaul transport when downlink frequency reuse is employed. These techniques typically reduce fronthaul bandwidth usage over at least some links of the fronthaul network. One such technique employs using broadcast transmission in order to communicate downlink fronthaul data to all RUs used to implement the associated gNB, even if the fronthaul data is not intended for some of those RUs. In comparison to unicast transmission, broadcast transmission can improve bandwidth usage over some fronthaul links (typically the links nearest the DU) with the trade-off of increased bandwidth usage over some fronthaul links (typically, the links nearest the RUs). With this broadcast technique, the interface used for communicating over the fronthaul network can be extended so that the broadcast downlink fronthaul data includes an RU mask field. The RU mask field includes a respective bit position associated with each RU used to implement the associated gNB. Each bit position is used to indicate whether the associated fronthaul data is intended for that RU. Each RU can quickly check its bit position in the RU mask field in order to determine if that RU should process the associated downlink fronthaul data or drop and ignore it. Additional information about this broadcast technique can be found in United patent application Ser. No. 17/169,052, filed on Aug. 5, 2021, and published as United States Patent Publication No. 2021/0243840, which is hereby incorporated herein by reference.

Other techniques for reducing fronthaul bandwidth usage employ multicast transmission. With one multicasting technique, a set of static multicast groups are defined and the Ethernet switches of the fronthaul network are configured to implement them. Each of the static multicast groups includes two RUs. A separate two-RU multicast group is defined for each pair of RUs that could possibly be included in the same simulcast group for a given UE. Then, if the size of the simulcast group for a given UE is limited to four RUs, the downlink fronthaul data can be communicated to all RUs in a given simulcast group using at most two multicast transmissions.

With another multicasting technique, the multicast groups used for downlink fronthaul data communication are defined dynamically. That is, when a simulcast group for a given UE is determined, the set of existing multicast groups can be searched to determine if one “matching” the UE's simulcast group has already been defined. A multicast group “matches” a UE's simulcast group if the multicast group includes all RUs that are included in the simulcast group and no other RUs that are not included in the simulcast group. That is, a multicast group matches a UE's simulcast group if the set of RUs in the multicast group is “equal” to the set of RUs in the simulcast group (with equality being defined as it is by set theory). If there is no matching multicast group, a new multicast group can be defined that matches the simulcast group. With this dynamic multicast technique, a multicast group (for example, the least used one) is deleted when it is necessary to define a new multicast group. While the fronthaul network is being configured to use a newly defined multicast group, the downlink fronthaul data can be communicated using broadcast transmission. Additional information about these static and dynamic multicast techniques can be found in U.S. patent application Ser. No. 16/413,385, filed on Nov. 21, 2019, and published as United States Patent Publication No. 2019/0357173, which is hereby incorporated herein by reference.

While these strategies can be used to reduce fronthaul bandwidth usage in connection with downlink frequency reuse, it is desirable to employ additional techniques in order to reduce fronthaul bandwidth usage over at least some links of the fronthaul network in connection with uplink frequency reuse.

### SUMMARY

One embodiment is directed to a system comprising a distributed unit and a plurality of radio units to wirelessly transmit and receive radio frequency signals to and from user equipment (UEs) using a wireless interface. Each of the radio units is associated with a respective set of antennas. The distributed unit is communicatively coupled to the plurality of radio units over a fronthaul network. The distributed unit and the radio units are configured to implement a base station to provide wireless services to UEs using a cell. The distributed unit is configured to, for each of the UEs, determine a respective subset of the radio units to wirelessly transmit to that UE based on information derived from Sounding Reference Signal (SRS) transmissions from that UE received at all of the radio units. The base station is configured so that each of the RUs is configured to: receive, at that RU, an SRS transmission from a UE; perform, by that RU, at least some of the high physical layer (PHY) baseband processing for the received SRS transmission; and transmit fronthaul data for the received SRS transmission to the distributed unit over the fronthaul network. The fronthaul data comprises a payload including data generated in connection with performing at least some of the high PHY baseband processing for the received SRS transmission.

Another embodiment is directed to a system comprising a distributed unit and a plurality of radio units to wirelessly transmit and receive radio frequency signals to and from user equipment (UEs) using a wireless interface. Each of the radio units is associated with a respective set of antennas. The distributed unit is communicatively coupled to the plurality of radio units over a fronthaul network. The distributed unit and the radio units are configured to implement a base station to provide wireless services to UEs using a cell. The base station is configured to receive an uplink transmission from a UE using multiple radio units; perform, by each of the multiple radio units, at least some physical layer (PHY) baseband processing for the uplink transmission; and start transmitting respective fronthaul data for the uplink transmission to the distributed unit over the fronthaul network from said multiple radio units at different times.

Another embodiment is directed to a system comprising a distributed unit and a plurality of radio units to wirelessly transmit and receive radio frequency signals to and from user equipment (UEs) using a wireless interface. Each of the radio units is associated with a respective set of antennas. The distributed unit is communicatively coupled to the plurality of radio units over a fronthaul network. The distributed unit and the radio units are configured to implement a base station to provide wireless services to UEs using a cell. The base station is configured to: determine a reduced target signal to interference plus noise ratio (SINR) for a UE; determine a reduced compressed bit resolution for a UE; use the reduced target SINR for performing uplink transmit power control for the UE; and use the compressed bit resolution for quantizing in-phase and quadrature (IQ) samples for at least some uplink transmissions from the UE.

The details of various embodiments are set forth in the accompanying drawings and the description below. Other features and advantages will become apparent from the description, the drawings, and the claims.

### BRIEF DESCRIPTION OF THE DRAWINGS

FIG. 1 is a block diagram illustrating one exemplary embodiment of a radio access network (RAN) system in which the uplink fronthaul bandwidth usage and contention reduction techniques described below can be used.

FIG. 2 comprises a high-level flowchart illustrating one exemplary embodiment of a method of communicating fronthaul data for uplink transmissions.

FIG. 3 comprises a high-level flowchart illustrating one exemplary embodiment of a method of communicating fronthaul data for uplink transmissions.

FIG. 4 illustrates one example of the operation of the method of FIG. 3 to receive an uplink transmission using three radio units.

FIG. 5 comprises a high-level flowchart illustrating one exemplary embodiment of a method of communicating fronthaul data for uplink transmissions.

Like reference numbers and designations in the various drawings indicate like elements.

### DETAILED DESCRIPTION

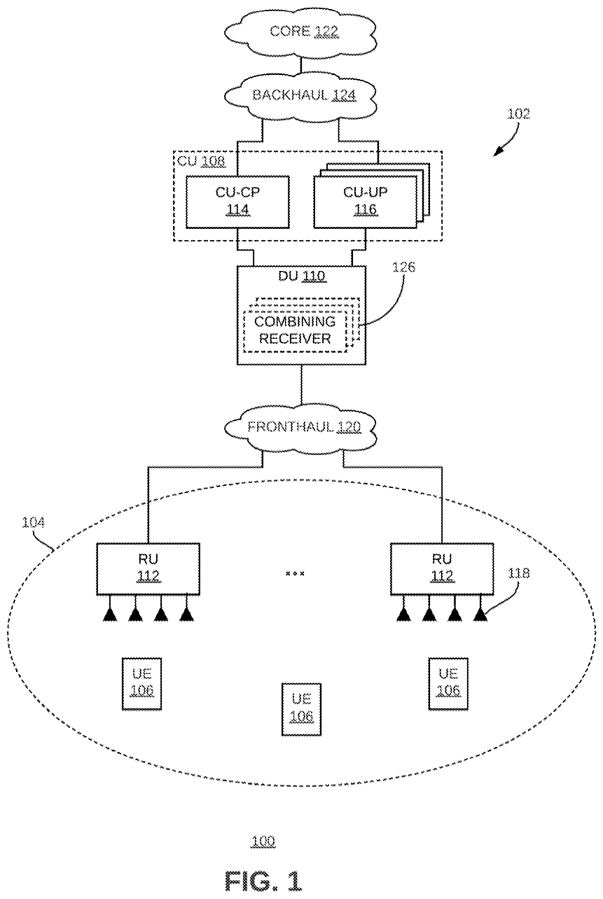

FIG. 1 is a block diagram illustrating one exemplary embodiment of a radio access network (RAN) system 100 in which the uplink fronthaul bandwidth usage and contention reduction techniques described below can be used.

The system 100 shown in FIG. 1 implements at least one base station entity 102 to serve a cell 104. Each such base station entity 102 can also be referred to here as a “base station” or “base station system” (and, which in the context of a fourth generation (4G) Long Term Evolution (LTE) system, may also be referred to as an “evolved NodeB”, “eNodeB”, or “eNB” and, in the context of a fifth generation (5G) New Radio (NR) system, may also be referred to as a “gNodeB” or “gNB”).

In general, each base station 102 is configured to provide wireless service to various items of user equipment (UEs) 106 served by the associated cell 104. Unless explicitly stated to the contrary, references to Layer 1, Layer 2, Layer 3, and other or equivalent layers (such as the Physical Layer or the Media Access Control (MAC) Layer) refer to layers of the particular wireless interface (for example, 4G LTE or 5G NR) used for wirelessly communicating with UEs 106. Furthermore, it is also to be understood that 5G NR embodiments can be used in both standalone and non-standalone modes (or other modes developed in the future) and the following description is not intended to be limited to any particular mode. Moreover, although some embodiments are described here as being implemented for use with 5G NR, other embodiments can be implemented for use with other wireless interfaces and the following description is not intended to be limited to any particular wireless interface.

In the specific exemplary embodiment shown in FIG. 1, each base station 102 is implemented as a respective 5G NR gNB 102 (only one of which is shown in FIG. 1 for ease of illustration). In this embodiment, each gNB 102 is partitioned into one or more central unit entities (CUs) 108, one or more distributed unit entities (DUs) 110, and one or more radio units (RUs) 112. In such a configuration, each CU 108 implements Layer 3 and non-time critical Layer 2 functions for the gNB 102. In the embodiment shown in FIG. 1, each CU 108 is further partitioned into one or more control-plane entities 114 and one or more user-plane entities 116 that handle the control-plane and user-plane processing of the CU 108, respectively.

Each such control-plane CU entity 114 is also referred to as a “CU-CP” 114, and each such user-plane CU entity 116 is also referred to as a “CU-UP” 116. Also, in such a configuration, each DU 110 is configured to implement the time critical Layer 2 functions and, except as described below, at least some of the Layer 1 functions for the gNB 102. In this example, each RU 112 is configured to implement the RF interface and the physical layer functions for the gNB 102 that are not implemented in the DU 110. Also, each RU 112 includes or is coupled to a respective set of one or more antennas 118 via which downlink RF signals are radiated to UEs 106 and via which uplink RF signals transmitted by UEs 106 are received.

In one implementation (shown in FIG. 1), each RU 112 is remotely located from each DU 110 serving it. Also, in such an implementation, at least one of the RUs 112 is remotely located from at least one other RU 112 serving the associated cell 104. In another implementation, at least some of the RUs 112 are co-located with each other, where the respective sets of antennas 118 associated with the RUs 112 are directed to transmit and receive signals from different areas.

Each RU 112 is communicatively coupled to the DU 110 serving it via a fronthaul network 120. The fronthaul network 120 can be implemented using a switched Ethernet network, in which case each RU 112 and each physical node on which each DU 110 is implemented includes one or more Ethernet network interfaces to couple each RU 112 and each DU physical node to the fronthaul network 120 in order to facilitate communications between the DU 110 and the RUs 112. In one implementation, the fronthaul interface promulgated by the O-RAN Alliance is used for communication between the DU 110 and the RUs 112 over the fronthaul network 120.

In such an example, each CU 108 is configured to communicate with a core network 122 of the associated wireless operator using an appropriate backhaul network 124 (typically, a public wide area network such as the Internet).

Although FIG. 1 (and the description set forth below more generally) is described in the context of a 5G embodiment in which each logical base station entity 102 is partitioned into a CU 108, DUs 110, and RUs 112 and some physical-layer processing is performed in the DUs 110 with the remaining physical-layer processing being performed in the RUs 112, it is to be understood that the techniques described here can be used with other wireless interfaces (for example, 4G LTE) and with other ways of implementing a base station entity (for example, using a conventional baseband band unit (BBU)/remote radio head (RRH) architecture). Accordingly, references to a CU, DU, or RU in this description and associated figures can also be considered to refer more generally to any entity (including, for example, any “base station” or “RAN” entity) implementing any of the functions or features described here as being implemented by a CU, DU, or RU.

Each CU 108, DU 110, and RU 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, each CU 108, DU 110, and RU 112, can be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF).

For example, in the exemplary embodiment shown in FIG. 1, each RU 112 is implemented as a PNF and is deployed in or near a physical location where radio coverage is to be provided and each CU 106 and DU 108 is implemented using a respective set of one or more VNFs deployed in a distributed manner within one or more clouds (for example, within an “edge” cloud or “central” cloud).

Each CU 108, DU 110, and RU 112, and any of the specific features described here as being implemented thereby, can be implemented in other ways.

Where multiple RUs 112 are used to implement a single gNB 102, multiple RUs 112 can be used by the gNB 102 to wirelessly transmit downlink data to a UE 106. The group of multiple RUs 112 used by the gNB 102 to wirelessly transmit to a UE 106 is also referred to here as the “simulcast zone” for the UE 106. Also, multiple RUs 112 can be used by the gNB 102 to receive data wirelessly transmitted by a UE 106 (for example, using a combining receiver 126). The group of multiple RUs 112 used by the gNB 102 to receive data wirelessly transmitted by a UE 106 is also referred to here as the “combining zone” for the UE 106.

Different UEs 106 can have different simulcast zones and combining zones. The corresponding fronthaul data transmitted to or received from a given UE 106 must be communicated over the fronthaul network 120 between the DU 110 and each RU 112 in that UE's simulcast zone or combining zone. The “size” of a simulcast zone or combining zone refers to the number of RU 112 that are included in that simulcast zone or combining zone. In general, the respective simulcast zone and combining zone for a UE 106 includes those RUs 112 that have the “best” or “strongest” signal reception or transmission characteristics for that UE 106.

In one exemplary embodiment, the simulcast zone and combining zone for each UE 106 can be determined by the serving DU 110 using a “signature vector” (SV) associated with that UE 106. Each signature vector includes a respective element for all of the RUs 112 of the gNB 102. For example, if the gNB 102 uses 32 RUs 112, each signature vector will include 32 elements, one for each of the 32 RUs 112. That is, each element of the signature vector corresponds to one of the RUs 112 of the gNB 102. Each element of the signature vector comprises one or more numerical values associated with the signal transmission or reception characteristics for that UE 106.

The elements of the signature vector for each UE 106 can be determined based on uplink transmissions from the UE 106. With such an approach, it is assumed that the relative signal reception metrics determined using such uplink transmissions are representative of which RUs 112 the UE 106 will have the best or strongest signal transmission and reception characteristics for both transmitting downlink transmissions to the UE 106 and for receiving uplink transmissions from the UE 106 for the purpose of determining the simulcast zone for the UE 106. For example, the signature vector can be determined based on received power measurements made at each of the RUs 112 of the gNB 102 for one or more uplink transmissions from the UE 106 (for example, initially Physical Random Access Channel (PRACH) transmissions and thereafter Sounding Reference Signals (SRS) transmissions). More specifically, each RU 112 of the gNB 102 will receive those uplink transmissions and can measure or otherwise determine a signal reception metric indicative of the power level of the transmissions received by that RU 112 from the UE 106. One example of such a signal reception metric is a signal-to-interference plus noise ratio (SINR).

In this exemplary embodiment, each gNB 102 is configured to determine a signature vector for a UE 106 upon connection to the cell 104 (for example, based on a PRACH transmission and/or a previously determined signature vector for that UE 106) and update the signature vector for the UE 106 over the course of the UE's connection to the cell 104 based on SRS transmissions from the UE 106. For the purposes of determining and updating a UE's signature vector, each RU 112 of the gNB 102 can communicate the respective signal reception metrics periodically without an explicit request from the DU 110 and/or can communicate the signal reception metrics in response to an explicit request from the DU 110 to do so (for example, using a polling mechanism).

One way that the respective signature vector determined for a given UE 106 can be used to determine the respective simulcast zone or combining zone for that UE 106 is by using the signature vector to calculate a “total zone power” and a “total available power” for that UE 106. The total zone power for a given UE 106 is the sum of the respective signal reception metrics determined for that UE 106 corresponding to the RUs 112 that are currently included in the zone that is being determined. The “total available power” for the UE 106 is the sum of the signal reception metrics determined for that UE 106 that correspond to all of the RUs 112. The simulcast zone or combining zone for a UE 106 can be determined by including enough RUs 112 in the simulcast zone for the UE 106 so that the total zone power for the UE 106 is within a threshold amount of the total available power for the UE 106. More specifically, a respective zone for a UE 106 can be determined by starting with an empty zone for that UE 106, sorting the RUs 112 based on the respective corresponding signal reception metrics determined for that UE 106 in descending order from strongest power to weakest power, and adding, to the zone for that UE 106, successive RUs 112 (according to the resulting sorted descending order) until the total zone power calculated for that UE 106 is within a threshold amount of the respective total available power calculated for that UE 106 or until the number of RUs 112 included in the respective zone for that UE 106 is equal to a predetermined maximum value (also referred to here as the “zone cap”). That is, the size of a simulcast zone or combining zone is limited to the zone cap.

In this exemplary embodiment, the gNB 102 is configured to use “frequency reuse.” As noted above, “downlink frequency reuse” refers to situations where separate downlink user data intended for different UEs 106 is simultaneously wirelessly transmitted to the UEs 106 using the same physical resource blocks (PRBs) for the same cell 104. Likewise, as noted above, “uplink frequency reuse” refers to situations where separate uplink user data is simultaneously wirelessly transmitted from different UEs 106 using the same PRBs for the same cell 104. Generally, for those PRBs where downlink or uplink frequency reuse is used, the respective simulcast zone or the combining zone for the multiple UEs 106 that are “in reuse together” have no RUs 112 in common. Typically, frequency reuse can be used when the UEs 106 in reuse together are sufficiently physically separated from each other so that the co-channel interference resulting from the different simultaneous wireless transmissions is sufficiently low (that is, where there is sufficient RF isolation).

Each gNB 102 is configured to use all RUs 112 to receive uplink transmissions from UEs 106 on the Physical Random Access Channel (PRACH). This is because the PRACH is used by a UE 106, among other things, to initially access the cell 104 and to re-establish access after being in an idle state and the gNB 102 may have no simulcast zone or combining zone assigned to the UE 106 or the simulcast zone or combining zone assigned to the UE 106 may be “stale” and not properly reflect the current location of the UE 106 (for example, if the location of the UE 106 changed significantly while the UE 106 was an idle state).

Also, in the exemplary embodiment described here in connection with FIG. 1, each gNB 102 is configured to update the signature vector (and, therefore, the simulcast zone and combining zone) for each UE 106 using SRS transmissions from that UE 106. As a consequence, in this exemplary embodiment, each gNB 102 is also configured to use all RUs 112 to receive uplink SRS transmissions from UEs 106.

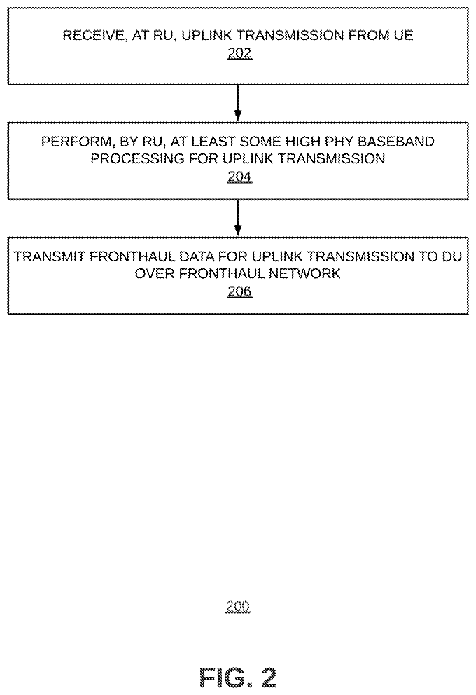

Because each gNB 102 is configured to use all RUs 112 to receive uplink PRACH and SRS transmissions from UEs 106, it can be beneficial to reduce fronthaul bandwidth usage associated with PRACH and SRS transmissions. One approach that can be used to reduce fronthaul bandwidth usage associated with uplink transmissions is illustrated in FIG. 2. It is important to note that in the following description, various techniques for reducing fronthaul bandwidth usage and/or contention associated with uplink transmissions from UEs 106 are described. Some of these techniques may be described below as being especially well suited for use with particular types of uplink transmissions. However, it is to be understood that the techniques described can be used with any type of uplink transmission. Moreover, one or more of the techniques described can be used in combination with each other.

FIG. 2 comprises a high-level flowchart illustrating one exemplary embodiment of a method 200 of communicating fronthaul data for uplink transmissions. The embodiment of method 200 shown in FIG. 2 is described here as being implemented using the gNB 102 of FIG. 2 (though it is to be understood that other embodiments can be implemented in other ways).

The blocks of the flow diagram shown in FIG. 2 have been arranged in a generally sequential manner for ease of explanation; however, it is to be understood that this arrangement is merely exemplary, and it should be recognized that the processing associated with method 200 (and the blocks shown in FIG. 2) can occur in a different order (for example, where at least some of the processing associated with the blocks is performed in parallel and/or in an event-driven manner). Also, most standard exception handling is not described for ease of explanation; however, it is to be understood that method 200 can and typically would include such exception handling.

Method 200 can be performed by each RU 112 of each gNB 102. The embodiment of method 200 described here in connection with FIG. 2 is described as being used for communicating fronthaul data for SRS transmissions in a base station where the DU 110 is configured to determine, for each UE 106, the simulcast zone for wirelessly transmitting to that UE 106 and/or the combining zone for wirelessly receiving from that UE 106 based on information derived from SRS transmissions from that UE 106 received at all of the RUs 112 of the associated gNB 102. However, it is to be understood that method 200 can be used for other types of uplink transmission (for example, PRACH transmissions).

Method 200 comprises receiving, by a RU 112, an uplink transmission (for example, a SRS transmission) from a UE 106 (block 202), performing, by that RU 112, at least some “high” physical layer (PHY) baseband processing for the received uplink transmission (block 204), and transmitting fronthaul data for the received uplink transmission to the DU 110 over the fronthaul network 120, where the payload of the fronthaul data comprises data generated in connection with performing at least some of the high PHY baseband processing (block 206). As noted above, the “high” PHY baseband processing is PHY baseband processing that would ordinarily be performed in the DU 110 (or similar baseband processing entity) if a “Functional Split 7-2x” were to be used.

The data generated in connection with performing at least some of the high PHY baseband processing can include, for example, “standard” data used in other processing specified by a related 3GPP 5G NR or 4G LTE (or other) public specification as well as “proprietary” data used for solely for other purposes (for example, proprietary signal reception data used solely in determining the simulcast zone and/or combining zone for a UE 106).

In one implementation of such an embodiment, each RU 112 performs all of the PHY baseband processing for the received uplink transmission (that is, each RU 112 performs all of the high PHY baseband processing for the received uplink transmission as well as all of the low PHY baseband processing for the received uplink transmission). That is, in such an implementation, a “Functional Split 6” can be used for one or more types of uplink transmission (for example, PRACH and/or SRS transmissions).

Also, a different functional split (for example, a “Functional Split 7-2x”) can be used for at least one other type of uplink transmissions (for example, Physical Uplink Shared Channel (PUSCH) and/or Physical Uplink Control Channel (PUCCH) transmissions).

By communicating fronthaul data that comprises data generated in connection with performing at least some of the high PHY baseband processing in each RU 112 for some uplink transmissions instead of, for example, as frequency-domain baseband IQ data, fronthaul bandwidth usage associated with those uplink transmissions can be greatly reduced. This is especially well suited for use with uplink transmissions that are received using all RUs 112 of the gNB 102, which in the exemplary embodiment described above in connection with FIG. 1 includes PRACH and SRS transmissions.

Other approaches to reducing fronthaul bandwidth usage and/or contention associated with uplink transmissions from UEs 106 can be used.

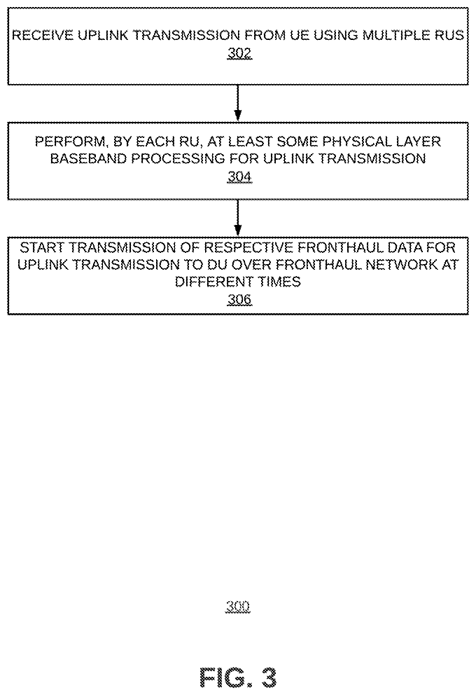

For example, if all RUs 112 used for receiving an uplink transmission from a UE 106 start transmitting fronthaul data for the uplink transmission at approximately the same time, there is an increased likelihood of contention over one or more communication links of the fronthaul network 120 (for example, over a communication link that couples the DU 110 to the rest of the fronthaul network 120). One approach to reducing the likelihood of this type of contention is illustrated in FIG. 3.

FIG. 3 comprises a high-level flowchart illustrating one exemplary embodiment of a method 300 of communicating fronthaul data for uplink transmissions. The embodiment of method 300 shown in FIG. 3 is described here as being implemented using the gNB 102 of FIG. 3 (though it is to be understood that other embodiments can be implemented in other ways).

The blocks of the flow diagram shown in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel and/or in an event-driven manner). Also, most standard exception handling is not described for ease of explanation; however, it is to be understood that method 300 can and typically would include such exception handling.

Method 300 can be performed by each RU 112 of each gNB 102. Moreover, although the embodiment of method 300 shown in FIG. 3 is described here as being performed for one type of uplink transmission, it is to be understood that method 300 can be performed for one or more types of uplink transmissions.

Method 300 comprises receiving an uplink transmission from a UE 106 using multiple RUs 112 (block 302), performing, by each of the multiple RUs 112, at least some physical layer (PHY) baseband processing for the received uplink transmission (block 304), and starting transmission of fronthaul data for the uplink transmission to the DU 110 over the fronthaul network 120 from the multiple RUs 112 at different times (block 306).

By spreading out when the various RUs 112 used to receive a given uplink transmission start transmitting fronthaul data to the DU 110 over the fronthaul network 120, the likelihood of contention over one or more communication links of the fronthaul network 120 can be reduced.

Each RU 112 receives the uplink transmission from the UE 106 using the set of antennas 118 associated with that RU 112 and performs the PHY baseband processing that the RU 112 is configured to perform for that type of uplink transmission. As noted above, the particular PHY baseband processing that is performed by the RU 112 for a given uplink transmission depends on which Functional Split is being used for that type of uplink transmission. For example, if the gNB 102 is configured to use a Functional Split 7-2x (for example, as specified by the O-RAN Alliance) for a given type of transmission, each RU 112 of the gNB 102 is configured to perform the low PHY baseband processing for that type of transmission (for example, including the fast Fourier transform (FFT), cyclic prefix (CP) removal, and any digital beamforming (if used)). In such an example, the fronthaul payload would comprise frequency-domain baseband IQ data for the uplink transmission (which can be in uncompressed or compressed form, depending on whether compression is used). In another example, if the gNB 102 is configured to use a Functional Split 6 for a given type of uplink transmission, each RU 112 of the gNB 102 is configured to perform all of the PHY baseband processing for that type of uplink transmission. In such an example, the fronthaul payload comprises the resulting transport blocks for the uplink transmission.

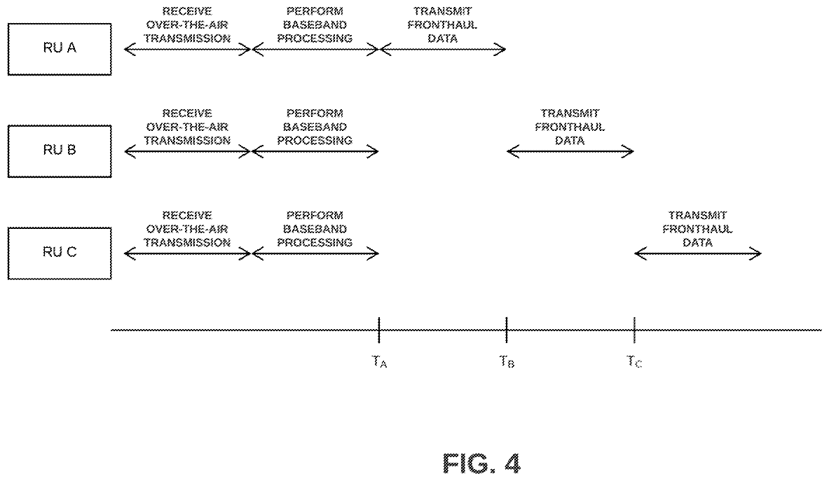

FIG. 4 illustrates one example of the operation of method 300 to receive an uplink transmission using three RUs 112 (individually referenced in FIG. 4 as RU A, RU B, and RU C). In the example shown in FIG. 4, RU A starts transmitting fronthaul data for the uplink transmission at a first time T_{A}, RU B starts transmitting fronthaul data for the uplink transmission at a second time T_{B}, and RU C starts transmitting fronthaul data for the uplink transmission at a third time T_{C}, where the first time T_{A}, the second time T_{B}, and the third time T_{c} all differ from one another. Again, by spreading out when RU A, RU B, and RU C start transmitting fronthaul data to the DU 110 over the fronthaul network 120, the likelihood of contention over one or more communication links of the fronthaul network 120 can be reduced.

In one implementation of method 300, each RU 112 of the gNB 102 is configured to use a parameter specifying a value for an offset that the RU 112 uses to determine when to start transmitting fronthaul data for a given type of uplink transmission. The offset can be defined relative to a boundary or other attribute of the associated uplink slot in which an uplink transmission is received (for example, an offset from the start or end of the associated uplink slot for the uplink transmission). This offset is also referred to here as an “uplink fronthaul offset.” By configuring each of the RUs 112 of the gNB 102 with an uplink fronthaul offset for a given type of uplink transmission that differs from the uplink fronthaul offsets used by all of the other RUs 112 of the gNB 102, the various RUs 112 used to receive any uplink transmission of that type will determine respective transmission start times that differ from each other. In such an implementation, the uplink fronthaul offsets used by the various RUs 112 can be configured manually (for example, during initial deployment of the gNB 102 using an appropriate management system). The uplink fronthaul offsets used by the various RUs 112 can also be configured automatically (for example, by the DU 110 or a RAN Intelligent Controller (RIC)). The uplink fronthaul offsets used by the various RUs 112 can be configured autonomously by each RU 112 (for example, configuring each uplink fronthaul offset with a randomly selected value or a value generated from some other piece of configuration data).

Another way to reduce the fronthaul bandwidth usage associated with the uplink transmissions is to use compression. One type of compression is block scaling. Block scaling reduces the bit resolution used to represent IQ samples communicated over the fronthaul network 120 by quantizing the original IQ samples to a reduced bit resolution (also referred to here as the “compressed bit resolution”). In order to minimize quantization error, a form of digital automatic gain control is used, which involves scaling the original IQ samples by a scaling factor before quantization using the compressed bit resolution. The scaling factor for a block of IQ samples is determined based on the maximum absolute value of all of the original IQ samples in the block. The scaling factor is transmitted along with the compressed IQ samples for use in decompressing the compressed IQ samples. In general, the amount of compression that can be achieved using block scaling is dependent on the average received signal power.

The 3GPP specifications define various forms of uplink transmit power control that are performed for 5G. In general, this transmit power control is a function of a target signal-to-interference plus noise ratio (SINR). The 3GPP specification defines how the target SINR is typically determined. Conventionally, a gNB determines the target SINR for each UE and then uses that determined value as the target SINR in performing uplink transmit power control for the UE.

Reducing the compressed bit resolution used in block scaling IQ samples tends to increase noise (due to increased quantization noise) and, as a result, tends to reduce the resulting SINR. In situations where the resulting reduced SINR is otherwise acceptable, the reduced compressed bit resolution could be used for block scaling.

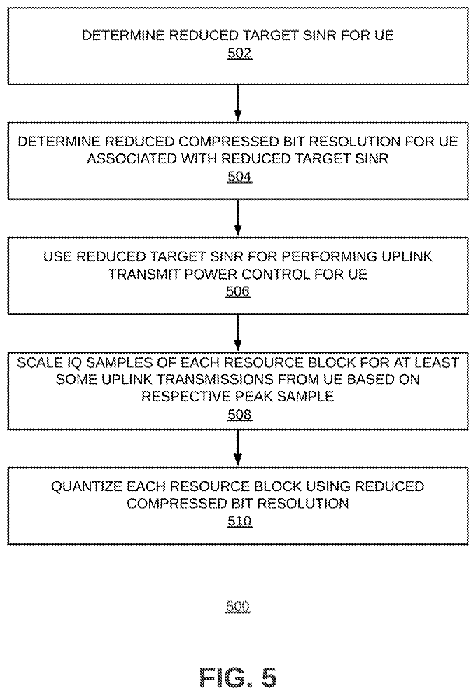

One approach to exploiting this effect in order to reduce fronthaul bandwidth usage associated with uplink transmissions is illustrated in FIG. 5.

FIG. 5 comprises a high-level flowchart illustrating one exemplary embodiment of a method 500 of communicating fronthaul data for uplink transmissions. The embodiment of method 500 shown in FIG. 5 is described here as being implemented using the gNB 102 of FIG. 5 (though it is to be understood that other embodiments can be implemented in other ways).

The blocks of the flow diagram shown in FIG. 5 have been arranged in a generally sequential manner for ease of explanation; however, it is to be understood that this arrangement is merely exemplary, and it should be recognized that the processing associated with method 500 (and the blocks shown in FIG. 5) can occur in a different order (for example, where at least some of the processing associated with the blocks is performed in parallel and/or in an event-driven manner). Also, most standard exception handling is not described for ease of explanation; however, it is to be understood that method 500 can and typically would include such exception handling.

Method comprises determining a reduced target SINR for a UE 106 (block 502), determining a reduced compressed bit resolution for the UE 106 associated with that reduced target SINR (block 504), using the reduced target SINR for performing uplink transmit power control for the UE 106 (block 506), scaling IQ samples of each resource block for at least some uplink transmissions from the UE 106 based on a respective peak sample in each such resource block (block 508), and quantizing each resource block using the reduced compressed bit resolution (block 510). The reduced target SINR and reduced compressed bit resolution for a given UE 106 are “reduced” in the sense that they are lower than they otherwise would be if the conventional techniques for determining the target SINR and compressed bit resolution were used. (The target SINR and compressed bit resolution that would otherwise have been determined using the conventional techniques for doing so are also referred to here as the “normal” target SINR and “normal” compressed bit resolution.)

Method 500 can be used in various ways. For example, method 500 can be used if the fronthaul network 120 is highly loaded and it would be beneficial to reduce the fronthaul bandwidth usage for communicating fronthaul data. Thereafter, if the loading of the fronthaul network 120 subsides, the compressed bit resolution and target SINR can be returned to their normal levels. Alternatively, method 500 can be used with UEs 106 that are reporting a Power Headroom (PHR) that is less than or equal to zero. These UEs 106 are good candidates for using a reduced target SINR since they are not able to achieve the normal target SINR.

The reduced target SINR and reduced compressed bit resolution for a given UE 106 can be determined so that they satisfy the following condition:

reduced compressed bit resolution=target SINR/6 bits+3 bits
where the reduced compressed bit resolution is expressed in bits and the reduced target SINR is expressed in decibels (dB). Satisfying this condition will tend to cause the quantization noise resulting from the reduced compressed bit resolution to be about 15 dB below the current interference and other noise for the UE 106.

The reduced target SINR is used in place of the normal target SINR when performing uplink transmit power control for the UE 106. Also, the reduced compressed bit resolution is used in place of the normal compressed bit resolution when quantizing IQ samples for at least some uplink transmissions from the UE 106 (for example, for PUSCH and PUCCH transmissions).

Method 500 can be used for all UEs 106 served by the gNB 102 or can be done selectively (that is, by reducing the compressed bit resolution for some but not all of the UEs 106). If it is done selectively, the subset of UEs 106 for which the compressed bit resolution is used can be changed from time to time (for example, using a round robin (or other) scheduling scheme). Also, the reduced compressed bit resolution can be used for all RUs 112 in the UE's combining zone or less than all of the RUs 112 in the UE's combining zone (for example, the reduced compressed bit resolution can be used for one or more RUs 112 in the UE's combining zone having the lowest SINR values in the signature vector for that UE 106).

The approaches to reducing fronthaul bandwidth usage and contention for uplink transmissions described in connection with FIGS. 2-5 can be used in various configurations. For example, in one configuration, the technique described above in connection with FIG. 2 is used for PRACH transmissions, the technique described above in connection with FIG. 3 is used for SRS transmissions, and the technique described above in connection with FIG. 5 is used for PUSCH and PUCCH transmissions. In another example, the technique described above in connection with FIG. 2 is used for PRACH and SRS transmissions, the technique described above in connection with FIG. 3 is used for PUSCH and PUCCH transmissions, and the technique described above in connection with FIG. 5 is used for PUSCH and PUCCH transmissions. Other configurations are possible.

Other embodiments can be implemented in other ways.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### EXAMPLE EMBODIMENTS

Example 1 includes a system comprising: a distributed unit; and a plurality of radio units to wirelessly transmit and receive radio frequency signals to and from user equipment (UEs) using a wireless interface, each of the radio units associated with a respective set of antennas; wherein the distributed unit is communicatively coupled to the plurality of radio units over a fronthaul network; wherein the distributed unit and the radio units are configured to implement a base station to provide wireless services to UEs using a cell; wherein the distributed unit is configured to, for each of the UEs, determine a respective subset of the radio units to wirelessly transmit to that UE based on information derived from Sounding Reference Signal (SRS) transmissions from that UE received at all of the radio units; and wherein the base station is configured so that each of the RUs is configured to: receive, at that RU, an SRS transmission from a UE; perform, by that RU, at least some of the high physical layer (PHY) baseband processing for the received SRS transmission; and transmit fronthaul data for the received SRS transmission to the distributed unit over the fronthaul network, wherein the fronthaul data comprises a payload including data generated in connection with performing at least some of the high PHY baseband processing for the received SRS transmission.

Example 2 includes the system of Example 1, wherein the base station is configured so that each of the RUs is configured to not perform any high PHY baseband processing for uplink transmissions other than SRS transmissions.

Example 3 includes the system of any of Examples 1-2, wherein the base station is configured so that each of the RUs is configured to perform at least some high PHY baseband processing for Physical Random Access Channel (PRACH) transmissions.

Example 4 includes a method of communicating fronthaul data for Sounding Reference Signal (SRS) transmissions in a system comprising a distributed unit and a plurality of radio units to wirelessly transmit and receive radio frequency signals to and from user equipment (UEs) using a wireless interface, each of the radio units associated with a respective set of antennas, wherein the distributed unit is communicatively coupled to the plurality of radio units over a fronthaul network, wherein the distributed unit and the radio units are configured to implement a base station to provide wireless services to UEs using a cell, the method comprising: at each of the RUs: receiving, at that RU, an SRS transmission from a UE; performing, by that RU, at least some of the high physical layer (PHY) baseband processing for the received SRS transmission; and transmitting fronthaul data for the received SRS transmission to the distributed unit over the fronthaul network, wherein the fronthaul data comprises a payload including data generated in connection with performing at least some of the high PHY baseband processing for the received SRS transmission; wherein the distributed unit is configured to, for each of the UEs, determine a respective subset of the radio units to wirelessly transmit to that UE based on information derived from the SRS transmissions from that UE received at all of the radio units.

Example 5 includes the method of Example 4, wherein the base station is configured so that each of the RUs is configured to not perform any high PHY baseband processing for uplink transmissions other than SRS transmissions.

Example 6 includes the method of any of Examples 4-5, wherein the base station is configured so that each of the RUs is configured to perform at least some high PHY baseband processing for Physical Random Access Channel (PRACH) transmissions.

Example 7 includes a system comprising: a distributed unit; and a plurality of radio units to wirelessly transmit and receive radio frequency signals to and from user equipment (UEs) using a wireless interface, each of the radio units associated with a respective set of antennas; wherein the distributed unit is communicatively coupled to the plurality of radio units over a fronthaul network; wherein the distributed unit and the radio units are configured to implement a base station to provide wireless services to UEs using a cell; wherein the base station is configured to: receive an uplink transmission from a UE using multiple radio units; perform, by each of the multiple radio units, at least some physical layer (PHY) baseband processing for the uplink transmission; and start transmitting respective fronthaul data for the uplink transmission to the distributed unit over the fronthaul network from said multiple radio units at different times.

Example 8 includes the system of Example 7, wherein the base station is configured to do at least one of: simultaneously wirelessly transmit separate downlink user data intended for different UEs using a same set of physical resource blocks (PRBs) for the cell using different subsets of the radio units; and simultaneously wirelessly receiving separate uplink user data intended for different UEs using a same set of PRBs for the cell using different subsets of the radio units.

Example 9 includes the system of any of Examples 7-8, wherein the base station is configured so that each radio unit is configured to use a parameter specifying a value for an offset that radio unit is configured to use to determine when to start transmitting the respective fronthaul data produced at that radio unit.

Example 10 includes a method of communicating fronthaul data for Sounding Reference Signal (SRS) transmissions in a system comprising a distributed unit and a plurality of radio units to wirelessly transmit and receive radio frequency signals to and from user equipment (UEs) using a wireless interface, each of the radio units associated with a respective set of antennas, wherein the distributed unit is communicatively coupled to the plurality of radio units over a fronthaul network, wherein the distributed unit and the radio units are configured to implement a base station to provide wireless services to UEs using a cell, the method comprising: receiving an uplink transmission from a UE using multiple radio units; performing, by each of the multiple radio units, at least some physical layer (PHY) baseband processing for the uplink transmission; and starting transmitting respective fronthaul data for the uplink transmission to the distributed unit over the fronthaul network from said multiple radio units at different times.

Example 11 includes the method of Example 10, wherein the base station is configured to do at least one of: simultaneously wirelessly transmit separate downlink user data intended for different UEs using a same set of physical resource blocks (PRBs) for the cell using different subsets of the radio units; and simultaneously wirelessly receiving separate uplink user data intended for different UEs using a same set of PRBs for the cell using different subsets of the radio units.

Example 12 includes the method of any of Examples 10-11, wherein the base station is configured so that each radio unit is configured to use a parameter specifying a value for an offset that radio unit is configured to use to determine when to start transmitting the respective fronthaul data produced at that radio unit.

Example 13 includes a system comprising: a distributed unit; and a plurality of radio units to wirelessly transmit and receive radio frequency signals to and from user equipment (UEs) using a wireless interface, each of the radio units associated with a respective set of antennas; wherein the distributed unit is communicatively coupled to the plurality of radio units over a fronthaul network; wherein the distributed unit and the radio units are configured to implement a base station to provide wireless services to UEs using a cell; wherein the base station is configured to: determine a reduced target signal to interference plus noise ratio (SINR) for a UE; determine a reduced compressed bit resolution for a UE; use the reduced target SINR for performing uplink transmit power control for the UE; and use the compressed bit resolution for quantizing in-phase and quadrature (IQ) samples for at least some uplink transmissions from the UE.

Example 14 includes the system of Example 13, wherein the base station is configured so that a same reduced target SINR and reduced compressed bit resolution are used for all UEs.

Example 15 includes the system of any of Examples 13-14, wherein the base station is configured to scale in-phase and quadrature (IQ) samples of each resource block for the at least some uplink transmissions from the UE based on a respective peak sample in each resource block and quantize each resource block using the reduced compressed bit resolution.

Example 16 includes the system of any of Examples 13-15, wherein the base station is configured to do at least one of: simultaneously wirelessly transmit separate downlink user data intended for different UEs using a same set of physical resource blocks (PRBs) for the cell using different subsets of the radio units; and simultaneously wirelessly receiving separate uplink user data intended for different UEs using a same set of PRBs for the cell using different subsets of the radio units.

Example 17 includes a method of communicating fronthaul data for Sounding Reference Signal (SRS) transmissions in a system comprising a distributed unit and a plurality of radio units to wirelessly transmit and receive radio frequency signals to and from user equipment (UEs) using a wireless interface, each of the radio units associated with a respective set of antennas, wherein the distributed unit is communicatively coupled to the plurality of radio units over a fronthaul network, wherein the distributed unit and the radio units are configured to implement a base station to provide wireless services to UEs using a cell, the method comprising: determining a reduced target signal to interference plus noise ratio (SINR) for a UE; determining a reduced compressed bit resolution for a UE; using the reduced target SINR for performing uplink transmit power control for the UE; and using the compressed bit resolution for quantizing in-phase and quadrature (IQ) samples for at least some uplink transmissions from the UE.

Example 18 includes the method of Example 17, wherein the base station is configured so that a same reduced target SINR and reduced compressed bit resolution are used for all UEs.

Example 19 includes the method of any of Examples 17-18, wherein the base station is configured to scale in-phase and quadrature (IQ) samples of each resource block for the at least some uplink transmissions from the UE based on a respective peak sample in each resource block and quantize each resource block using the reduced compressed bit resolution.

Example 20 includes the method of any of Examples 17-19, wherein the base station is configured to do at least one of: simultaneously wirelessly transmit separate downlink user data intended for different UEs using a same set of physical resource blocks (PRBs) for the cell using different subsets of the radio units; and simultaneously wirelessly receiving separate uplink user data intended for different UEs using a same set of PRBs for the cell using different subsets of the radio units.

What is claimed is:

1. A system comprising:
a distributed unit; and
a plurality of radio units to wirelessly transmit and receive radio frequency signals to and from user equipment (UEs) using a wireless interface, each of the radio units associated with a respective set of antennas;
wherein the distributed unit is communicatively coupled to the plurality of radio units over a fronthaul network;
wherein the distributed unit and the radio units are configured to implement a base station to provide wireless services to UEs using a cell;
wherein the distributed unit is configured to, for each of the UEs, determine a respective subset of the radio units to wirelessly transmit to that UE based on information derived from Sounding Reference Signal (SRS) transmissions from that UE received at all of the radio units; and
wherein the base station is configured so that each of the RUs is configured to:
receive, at that RU, an SRS transmission from a UE;
perform, by that RU, at least some of the high physical layer (PHY) baseband processing for the received SRS transmission; and
transmit fronthaul data for the received SRS transmission to the distributed unit over the fronthaul network, wherein the fronthaul data comprises a payload including data generated in connection with performing at least some of the high PHY baseband processing for the received SRS transmission.

2. The system of claim 1, wherein the base station is configured so that each of the RUs is configured to not perform any high PHY baseband processing for uplink transmissions other than SRS transmissions.

3. The system of claim 1, wherein the base station is configured so that each of the RUs is configured to perform at least some high PHY baseband processing for Physical Random Access Channel (PRACH) transmissions.

4. A method of communicating fronthaul data for Sounding Reference Signal (SRS) transmissions in a system comprising a distributed unit and a plurality of radio units to wirelessly transmit and receive radio frequency signals to and from user equipment (UEs) using a wireless interface, each of the radio units associated with a respective set of antennas, wherein the distributed unit is communicatively coupled to the plurality of radio units over a fronthaul network, wherein the distributed unit and the radio units are configured to implement a base station to provide wireless services to UEs using a cell, the method comprising:
at each of the RUs:
receiving, at that RU, an SRS transmission from a UE;
performing, by that RU, at least some of the high physical layer (PHY) baseband processing for the received SRS transmission; and
transmitting fronthaul data for the received SRS transmission to the distributed unit over the fronthaul network, wherein the fronthaul data comprises a payload including data generated in connection with performing at least some of the high PHY baseband processing for the received SRS transmission;
wherein the distributed unit is configured to, for each of the UEs, determine a respective subset of the radio units to wirelessly transmit to that UE based on information derived from the SRS transmissions from that UE received at all of the radio units.

5. The method of claim 4, wherein the base station is configured so that each of the RUs is configured to not perform any high PHY baseband processing for uplink transmissions other than SRS transmissions.

6. The method of claim 4, wherein the base station is configured so that each of the RUs is configured to perform at least some high PHY baseband processing for Physical Random Access Channel (PRACH) transmissions.

7. A system comprising:
a distributed unit; and
a plurality of radio units to wirelessly transmit and receive radio frequency signals to and from user equipment (UEs) using a wireless interface, each of the radio units associated with a respective set of antennas;
wherein the distributed unit is communicatively coupled to the plurality of radio units over a fronthaul network;
wherein the distributed unit and the radio units are configured to implement a base station to provide wireless services to UEs using a cell;
wherein the base station is configured to:
receive an uplink transmission from a UE using multiple radio units;
perform, by each of the multiple radio units, at least some physical layer (PHY) baseband processing for the uplink transmission; and
start transmitting respective fronthaul data for the uplink transmission to the distributed unit over the fronthaul network from said multiple radio units at different times.

8. The system of claim 7, wherein the base station is configured to do at least one of:
simultaneously wirelessly transmit separate downlink user data intended for different UEs using a same set of physical resource blocks (PRBs) for the cell using different subsets of the radio units; and
simultaneously wirelessly receiving separate uplink user data intended for different UEs using a same set of PRBs for the cell using different subsets of the radio units.

9. The system of claim 7, wherein the base station is configured so that each radio unit is configured to use a parameter specifying a value for an offset that radio unit is configured to use to determine when to start transmitting the respective fronthaul data produced at that radio unit.

10. A method of communicating fronthaul data for Sounding Reference Signal (SRS) transmissions in a system comprising a distributed unit and a plurality of radio units to wirelessly transmit and receive radio frequency signals to and from user equipment (UEs) using a wireless interface, each of the radio units associated with a respective set of antennas, wherein the distributed unit is communicatively coupled to the plurality of radio units over a fronthaul network, wherein the distributed unit and the radio units are configured to implement a base station to provide wireless services to UEs using a cell, the method comprising:
receiving an uplink transmission from a UE using multiple radio units;
performing, by each of the multiple radio units, at least some physical layer (PHY) baseband processing for the uplink transmission; and
starting transmitting respective fronthaul data for the uplink transmission to the distributed unit over the fronthaul network from said multiple radio units at different times.

11. The method of claim 10, wherein the base station is configured to do at least one of:
simultaneously wirelessly transmit separate downlink user data intended for different UEs using a same set of physical resource blocks (PRBs) for the cell using different subsets of the radio units; and
simultaneously wirelessly receiving separate uplink user data intended for different UEs using a same set of PRBs for the cell using different subsets of the radio units.

12. The method of claim 10, wherein the base station is configured so that each radio unit is configured to use a parameter specifying a value for an offset that radio unit is configured to use to determine when to start transmitting the respective fronthaul data produced at that radio unit.

13. A system comprising:
a distributed unit; and
a plurality of radio units to wirelessly transmit and receive radio frequency signals to and from user equipment (UEs) using a wireless interface, each of the radio units associated with a respective set of antennas;
wherein the distributed unit is communicatively coupled to the plurality of radio units over a fronthaul network;
wherein the distributed unit and the radio units are configured to implement a base station to provide wireless services to UEs using a cell;
wherein the base station is configured to:
determine a reduced target signal to interference plus noise ratio (SINR) for a UE;
determine a reduced compressed bit resolution for a UE;
use the reduced target SINR for performing uplink transmit power control for the UE; and
use the compressed bit resolution for quantizing in-phase and quadrature (IQ) samples for at least some uplink transmissions from the UE.

14. The system of claim 13, wherein the base station is configured so that a same reduced target SINR and reduced compressed bit resolution are used for all UEs.

15. The system of claim 13, wherein the base station is configured to scale in-phase and quadrature (IQ) samples of each resource block for the at least some uplink transmissions from the UE based on a respective peak sample in each resource block and quantize each resource block using the reduced compressed bit resolution.

16. The system of claim 13, wherein the base station is configured to do at least one of:
simultaneously wirelessly transmit separate downlink user data intended for different UEs using a same set of physical resource blocks (PRBs) for the cell using different subsets of the radio units; and
simultaneously wirelessly receiving separate uplink user data intended for different UEs using a same set of PRBs for the cell using different subsets of the radio units.

17. A method of communicating fronthaul data for Sounding Reference Signal (SRS) transmissions in a system comprising a distributed unit and a plurality of radio units to wirelessly transmit and receive radio frequency signals to and from user equipment (UEs) using a wireless interface, each of the radio units associated with a respective set of antennas, wherein the distributed unit is communicatively coupled to the plurality of radio units over a fronthaul network, wherein the distributed unit and the radio units are configured to implement a base station to provide wireless services to UEs using a cell, the method comprising:
determining a reduced target signal to interference plus noise ratio (SINR) for a UE;
determining a reduced compressed bit resolution for a UE;
using the reduced target SINR for performing uplink transmit power control for the UE; and
using the compressed bit resolution for quantizing in-phase and quadrature (IQ) samples for at least some uplink transmissions from the UE.

18. The method of claim 17, wherein the base station is configured so that a same reduced target SINR and reduced compressed bit resolution are used for all UEs.

19. The method of claim 17, wherein the base station is configured to scale in-phase and quadrature (IQ) samples of each resource block for the at least some uplink transmissions from the UE based on a respective peak sample in each resource block and quantize each resource block using the reduced compressed bit resolution.

20. The method of claim 17, wherein the base station is configured to do at least one of:
simultaneously wirelessly transmit separate downlink user data intended for different UEs using a same set of physical resource blocks (PRBs) for the cell using different subsets of the radio units; and
simultaneously wirelessly receiving separate uplink user data intended for different UEs using a same set of PRBs for the cell using different subsets of the radio units.
